(19) United States
(12) Patent Application Publication
(10) Pub. No.: US 2006/0016733 A1
(43) Pub. Date: Jan. 26, 2006

(54) Dynamic separator

(76) Inventors: Burkit Mainin, Karaganda (KZ); Gulnar Ermekova, Karaganda (KZ); Zhanat Mainina, Karaganda (KZ); Zhibek Mainina, Karaganda (KZ)

Correspondence Address: FRASER MARTIN BUCHANAN MILLER LLC, 132C WEST SECOND STREET, PERRYSBURG, OH, 43551-1401, US

(21) Appl. No.: 10/523,860

(22) PCT Filed: Aug. 4, 2003
(86) PCT No.: PCT/KZ03/00005

§ 371 Date: Aug. 11, 2005

(30) Foreign Application Priority Data
Aug. 19, 2002 (KZ) 2002/1085.1

(51) Int. Cl. B07B 1/42

(52) U.S. Cl. 209/364

(57) ABSTRACT

The invention relates to mineral processing and can be used for the metal mining, coal and other industries. The inventive device comprises two movable trays which are pivotally connected to each other and actuated by a specially constructed shaft. The positive motion of the trays makes it possible to obtain a uniform pulse distribution, thereby preconditioning the stimulation of mineral processing. In addition, said invention substantially reduces energy consumption for mineral processing, simplifies the structural design of the device, and significantly increases the reliability thereof. The test of the pilot device displayed good technical results of mineral processing and confirmed the high reliability and operability of said easy producible device.

### CROSS-REFERENCE DATA

The present patent application in an entry in national phase of the international patent application no. PCT/KZ2003/000005 filed Aug. 4, 2003, which claims priority of Kazakh patent application no. 2002/1085.1 filed Aug. 19, 2002.

### FIELD OF THE INVENTION

This paper is dealing with processing minerals and can be used both in ore and mining industries, as well as in some others.

### BACKGROUND OF THE INVENTION

There are certain jigging units with movable sieve (Directory on ore processing. Main processes. Moskow, Nedra, 1983, p.p. 53-54). The sieve is given bow-shaped movement with horizontal displacement towards the place of loading material with the sieve moving down and protruding it forward under moving up. As a result the positive effect is achieved due to simultaneous up going of the whole bed and pushing separating material forward along the sieve, the regulation of the sieve movement is done by replacement of the plates with cranks on the movable disks.

Disadvantage of the device is insufficient disintegration of the movable bed in the loading part of the sieve and mixing up of disintegrating fractions in the loading part. Thus, the efficiency of material disintegration is low. Due to these reasons as well as some others the type of the devices with the movable sieve did not find wide application.

There are jiggers with unmovable sieve, such as “THE WEMCO REMER JIG” (Annotation of the device—“THE WEMKO REMER JIG” WEMCO EGUIPMENT, COAL PLANTS 315C Street, St. Albans, W. Va.).

The device has an upper unmovable trough with a sieve and a lower movable one, both are connected by rubber diaphragm along perimeter. The lower trough gets vertical reciprocating movement by special doubled eccentric mechanism. As a result vertical pulsation of under-sieve water is being achieved that is very important for jigging.

Disadvantages of the machine are complexity of the design due to eccentric unit construction, high inertia of the lower part of the machine that results in high energy-consumption because of the fact that each cycle of jigging needs upraising of the lower trough with the whole amount of water, low efficiency of jigging as there is no simultaneous upraising of the whole bed that is characteristic of all jiggers with unmovable sieve.

As a prototype of a jigger, the machine with vibrating of the jigging sieve and water in counter-phase is used (Jigging machine. International Patent Classification B03B 05/16, international publication number: WO 02/13974, international publication date: 21 Feb. 2002 (21 Feb. 2002)). The machine consists of troughs connected hingedly by double-arm levers, the upper having a sieve inside and continuous flexible membrane at the bottom interacting with lower trough. The double-arm levers are hinged upon supports. Reciprocating movement of troughs is achieved by setting a drive in the center of axle of double-arm levers rotation, for example, turning gate hydraulic engine. Thereby reciprocating movement of troughs is taking place both in vertical surface—for jigging performance and in the horizontal one—for transporting processing mineral to the place of unloading out of the jigger. The double-arm levers together with troughs form a system of hinge parallelogram, that results in uniform pulsation of under-sieve water and simultaneous uprising of the whole bed, that's very important for efficiency of jigging.

Because of the cinematic scheme and correspondingly the design itself the disadvantages of the machine are that the troughs make reciprocal motion and as result of this the considerable part of the drive capacity is spent to overcome inertia rather than to the useful performance. Besides it result in considerable additional loads over the drive and hinges of the machine that is negatively effects reliability of the machine.

### SUMMARY OF THE INVENTION

Technical task of the invention is to design a simple and reliable in construction unit with low power-consuming jigging process.

The separator we offer by our invention consists of two movable troughs, hinged via crankshafts. The upper trough has a sieve. The unit has flexible membrane made in the form of an endless stripe, one edge of that is achieved to the upper tough, and the other—to the lower one. Movement of toughs is achieved by torque transmission from a drive (e.g. Electric engine) to the crankshaft, and from it to the troughs. The troughs make advance movement along curved closed trajectory—circumference. Extreme and inner cranks of the crankshaft are located in respect to each other with the displacement of 180 degree, that provides the movement of troughs in counter-phase. In this case the design of the unit is simplified considerably due to absence of the usage of double-arm levers, reliability is increased thanks to removal inertia forces and energy consumption of jigging is decreased as both troughs move along closed trajectory and their masses perform only positive work. Negative effect upon the base is minimized due to full balance of moving masses of the unit.

To improve reliability durability and simplicity of the flexible membrane the latter has been done not as a continuous but as an endless stripe both edges of which are attached to the troughs.

Thus, constructive differences of this unit give possibilities to solve the technical task—decreasing power intensity, reduction design and increasing reliability of the unit. Consequently, these differences are very essential. To our mind, they give possibility to provide the proper technical level to the given invention. Industrial usage of it is out of any doubt.

### BRIEF DESCRIPTION OF THE DRAWINGS

FIG. 1—kinematic scheme of the unit.

FIG. 2—the design of the unit, side sight.

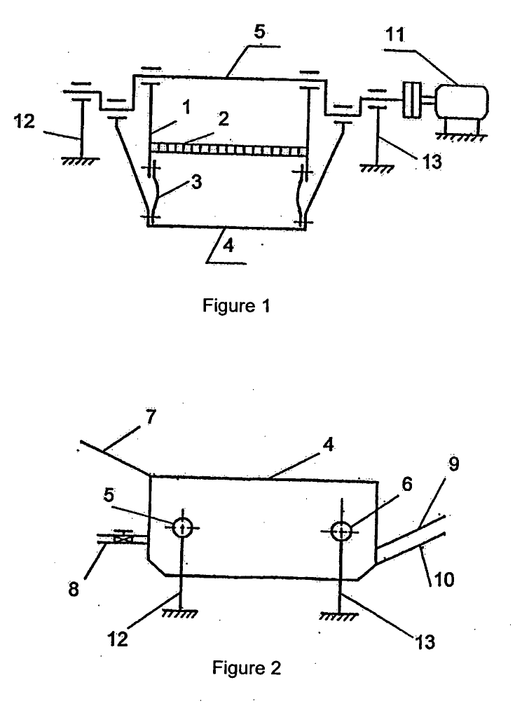

### DETAILED DESCRIPTION OF THE EMBODIMENTS

The unit consists of upper trough 1 with sieve 2 and flexible membrane 3 attached at the bottom, lower trough 4 with attached to it flexible membrane 3 and hinged to upper trough 1 with the help of crankshafts 5 and 6. At the back butt end of upper trough 1 there is a loading unit 2, water along flexible hose 8 is given to under sieve 2. Unloading processing products is done through unloading units 9 and 10 placed on front butt end of trough 1. The troughs are put into operation vie the crankshaft by drive 11. Crankshafts 5 and 6 are hinged on supports 12 and 13.

The given device operates in the following way. Material processed is given onto upper trough 1 out of loading unit 7. Drive 11 via crankshaft gives advance movement to troughs 1 and 4. Synchronously with the movement of lower trough 4 downward replacement of upper 1 with sieve 2 takes place upwards that provides uprising of the whole bed. With the movement of upper trough 1 together with sieve 2 downward lower trough 4 synchronously moves upwards and produces vertical pulsation of under-sieve water. Products processing are removed through unloading units 9 and 10. Loss of water during unloading is compensated by permanent supplying of water though hose 8.

### INDUSTRIAL USAGE

Additional technical result of using the given invention is its multi functionality—possibility to use it as transporting device or screen. Kinematic scheme of the given device permits to increase its individual capacity many times due to simple increasing its linear dimensions and changing the frequency of troughs pulsation without complication of the unit's design.

Basing on the experience of using such devices for a certain concrete kind of a mineral of a certain size there is optimal amplitude of vibrating. That's why to operate the process of effective dressing under given optimal amplitude it's enough to regulate the frequency of vibration, made by the usage of regulated electro- or hydraulic circuit.

Tests of the pilot sample of the device proved low energy intensity of processing and high reliability of the device simple both in manufacturing and using.

1. Dynamic separator consisting of the upper trough with the sieve and the lower one hinged between each and other, then, drive, units for loading material, water supplying and discharging products of the processing, flexible membrane and supports being different due to the fact the troughs are hinged between each other via crankshafts, hinged on the supports, as for membrane, it is made in the form of the endless stripe, the edges of which are attached to the troughs.
